(19) United States
(12) Patent Application Publication
(10) Pub. No.: US 2007/0200010 A1
(43) Pub. Date: Aug. 30, 2007

(54) QUICK-EXCHANGE TAMPER-PROOF SANITARY DISCHARGE NOZZLE

(76) Inventor: Philippe Henri Girerd, Mildlothian, VA (US)

Correspondence Address: Philippe H. Girerd, 13440 Stonegate Rd., Midlothian, VA, 23113, US

(21) Appl. No.: 11/680,616

(22) Filed: Feb. 28, 2007

Related U.S. Application Data
(60) Provisional application No. 60/777,398, filed on Feb. 28, 2006.

(51) Int. Cl. B05B 1/26

(52) U.S. Cl. 239/461

(57) ABSTRACT

The present invention relates to a fluid dispensing assembly comprising a removable nozzle with locking surfaces that lock into a base member. The base member which is embodied here as the bubbler head of a drinking fountain having locking surfaces allowing the nozzle to remain locked to the base member. The user of this invention can quickly exchange a contaminated nozzle by accessing a locking mechanism by a specific tamper-proof key which displaces the locking surfaces to allowing the nozzle to be unlocked from the base member. The nozzle can be identified by a date stamp

### CROSS-REFERENCE TO RELATED APPLICATIONS

This application claims the benefit of provisional patent application Ser. No. 60/777,398, filed 2006 Feb. 28 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to fluid dispensing systems, specifically to drinking fountains and the like and to bubbler heads which dispense a stream of water to the thirsty.

2. Prior Art

From the ubiquitous public drinking fountains of ancient Rome which spilled onto the streets to the elaborate sabils of the Middle East to modern day water coolers, providing safe and readily available drinking water to the public has been a central component of human activity evidenced in all known civilizations. A plurality of sources and reservoirs of contamination can contribute to the microbial content of water dispensed to the recipient of publicly distributed water. Solutions addressing microbial contamination related to fluid dispensing systems have, to date, concerned themselves with interdicting the arrival of microbes to the discharge nozzle. In this vein, U.S. Pat. No. 615,182 to Hyde and Buckley (1898) discloses a method for preventing the user of a water fountain from applying his or her lips to the outlet of the water being dispensed by placing the discharge nozzle at the bottom of an inverted cone. This solution addresses the problem of direct contact with the discharge nozzle by those with communicable diseases. Hong, in U.S. Pat. No. 7,025,282 B2 (2006), teaches that a hydraulically activated protective cover can aid in preventing contamination of the bubbler head of a drinking fountain. Although apparently beneficial, these types of solutions ignore the fact that microbes, being by definition microscopic, can spontaneously become suspended in air. Microbes can be airborne individually, on solid particle such as dust, or in their dormant form as spores. Additionally, at times, microbes find themselves airborne through propulsion resulting from a cough or sneeze. This type of dispersion of microbes results in the inevitable colonization of moist surfaces by microbes.

Microbes are known to form biofilms on any surface that remains moist or wet for a substantial time. A biofilm is composed of bacteria and possibly other microbes held in place by a polymeric matrix. Biofilms provide multiple benefits to organisms such as: anchoring in a favorable niche, resistance to environmental factors (antibiotics, disinfectants including bleach, transient temperature fluctuations), and division of metabolic burden (sharing of functions in multi-species biofilms). Biofilms greatly enhance the chances of survival of microorganisms in a majority of environments. Present evidence suggests that bacteria exist in biofilms as a “default setting” and that the typical image of planktonic (free-floating) bacteria represents only a small fraction of bacterial life enabling spread to new niches. Bacteria require both water and a renewing supply of various substrates for carrying on their metabolic processes. Moist surfaces provide the ideal environment for the formation of biofilms. Biofilms form over time on practically all such environments. Many problems arise from this process. Two costly examples of moist surfaces, their biofilms and resulting problems are: the human mouth (dental plaque and gingivitis leading to heart disease), and the hulls of ships (multi-species biofilms leading to increased flow resistance and higher fuel consumption). It has been newly recognized that the nozzles of water fountains contain very high concentrations of bacteria. This is an environment which is ideal for the formation of a biofilm. A biofilm in this area becomes not only an ideal site for bacterial proliferation but since biofilms are composed of not only microbes but a mesh-like network of exopolymeric molecules they become a reservoir for other entities such as viruses. Because of the proximity of the nozzle to the nasopharyngeal region of various individuals over time, the possibility of contamination by adenoviruses and influenza viruses is great. Also, viruses aerosolized by sneezing and coughing may settle into this favorable environment. Due to the transient physical force of water coursing through the nozzle during use a small quantity of viruses may be released and ingested by the user of the drinking fountain. Because microorganisms require sources of energy and various nutrients the formation of a biofilm in the environment of a nozzle is largely limited to the area immediately surrounding and just inside of the opening of the nozzle. Typical disinfectants, even strong ones like bleach, may be unable to destroy biofilms even under ideal circumstances.

The environment of a discharge nozzle compounds the problem because it is a small, deep area and physically difficult to clean and it is also typically full of water thus diluting any cleanser applied. This problem has been addressed by Labib et al. U.S. Pat. No. 6,326,340 in the context of rinse water delivery to dental units by use of aqueous solutions of surfactants and hydrogen peroxide combined with inert solid particles and turbulent flow caused by gas under pressure to both chemically and mechanically disrupt biofilms. This approach requires special cleansers and elaborate equipment to disrupt the biofilms. In the context of a bubbler head this method would require its disassembly to effectuate proper cleaning.

Cheng U.S. Pat. No. 6,866,206 B2 (2005) and Dreibelbis U.S. Pat. No. 3,567,121 (1971) teach of bubbler heads with separate potentially exchangeable nozzles. They are, however held in place by screw threads and not expeditiously exchanged. Dreibelbis and Turner U.S. Pat. No. 4,060,198 (1977) propose a removably fitted nozzle. The nozzle is pressure fitted with no reversible locking means making removal and insertion difficult due to friction. This also allows tampering by simply prying with any flat object.

Locking fluid couplings described by Gillespie U.S. Pat. No. 244,804 (1881), Bonadio U.S. Pat. No. 1,039,354 (1912) provide the joining of fluid conduits but no provision for disconnecting said conduits. Tisserat U.S. Pat. No. 4,561,682 (1985), Traviglini U.S. Pat. No. 5,639,490 (1997) and Washburn et al. U.S. Pat. No. 6,921,114 B1 teach of couplings of fluid conduits with removable locking keys. These, however depend on the presence of the keys to remain locked and are therefore not tamper-proof. Yeh U.S. Pat. No. 5,799,988 details a locking fluid conduit coupling which can be locked and unlocked by turning a coupling sleeve but also fails to be tamper-proof.

### OBJECTS AND ADVANTAGES

It is therefore an object of the invention to reduce microbial contamination in the nozzle portion of a fluid dispensing system. It is another object of the invention to provide a nozzle portion of a fluid dispensing system to be easily and quickly exchanged. It is another object of the invention to provide a nozzle which resists tampering by use of a specific key. In accordance with the present invention, there is provided a discharge nozzle and apparatus for dispensing water in a sanitary manner which can be easily and quickly replaced yet also be resistant to tampering.

### SUMMARY

In accordance with the present invention, a fluid dispensing assembly comprises a removable nozzle with locking surfaces that lock into a base member, a base member with locking surfaces allowing said nozzle to remain locked to said base member, and also allowing access to a locking mechanism by a specific key means to unlock said nozzle by displacing said locking surfaces to allow unlocking of said nozzle from said base member.

### DRAWINGS—FIGURES

FIG. 1 is a perspective view of a quick-exchange sanitary discharge nozzle.

FIG. 2 is a sectional view of the quick-exchange sanitary discharge nozzle embedded in a base member portion of the device.

FIG. 3 is a side elevation of the base member assembly with the discharge nozzle in place illustrating the openings to admit the key.

FIG. 4 is a top detail view of the base member with the discharge nozzle in place combined with a top view of an anti-tamper key with dashed arrows to indicate the movement needed to use said key.

FIG. 5 is a front elevation view of the anti-tamper key.

FIG. 6 is a sectional view of the quick-exchange sanitary discharge nozzle embedded in the bubbler head portion of the device with the anti-tamper key inserted. The flexible locking arms of the discharge nozzle are seen to be flexed.

FIG. 7 is a perspective view of a further form of the quick-exchange sanitary discharge nozzle showing a date stamp identifier.

### DRAWINGS—REFERENCE NUMERALS 10 discharge nozzle 11 nozzle head 12 nozzle head opening 13 cylindrical insert conduit 14 insert conduit opening 15 flexible locking arm 16 locking head 17 locking head shoulder surface 18 locking head nose 19 o-ring shoulder 20 o-ring 21 tubular sleeve conduit 22 base member 23 locking arm cavity 24 locking shoulder catch surface 25 anti-tamper key channel 27 anti-tamper key 30 key prong 31 key prong tip 32 slanted key prong end 33 key grip 40 date stamp identifier

### DETAILED DESCRIPTION—PREFERRED EMBODIMENT

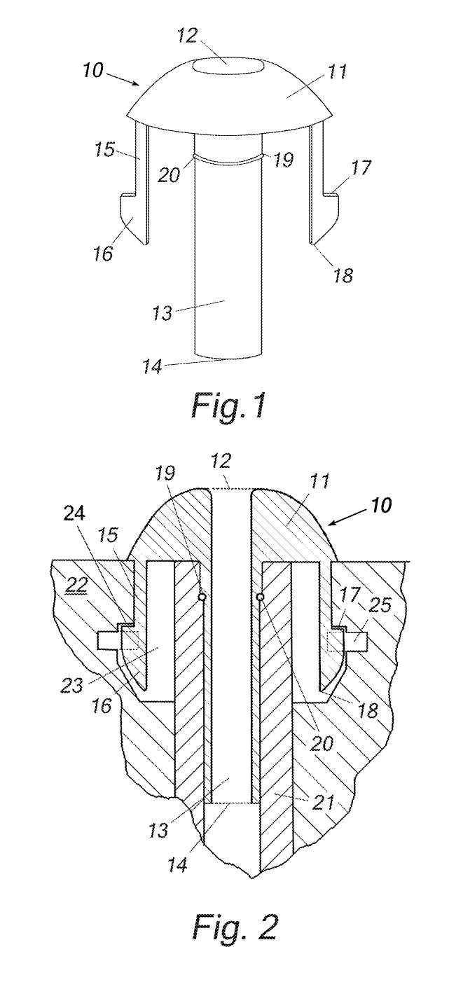

FIG. 1 shows an embodiment of a unitary discharge nozzle 10 illustrating a nozzle head 11 which forms a mound representing the visible portion of the discharge nozzle 10 when it is in place. Atop of the nozzle head 11 there is a nozzle head opening 12 from whence emanates the liquid being dispensed. The nozzle head 11, in turn, is shown atop of a cylindrical insert conduit 13 which provides a means for passage of fluid through the discharge nozzle 10. Projecting downwards from the nozzle head 11 are two flexible locking arms 15 which attach at their top ends to the nozzle head 11 and feature locking heads 16 at their bottom ends. Each locking head 16 has a locking head shoulder surface 17 which is substantially perpendicular to the direction in which the locking arm 15 projects out from the nozzle head 11. Each locking head 16 also has a locking head nose 18 on the opposite side of and below the locking arm 15 from the locking shoulder 17. The cylindrical insert conduit 13 is shown to be of two distinct diameters the larger of the diameters being above an o-ring shoulder 19. An o-ring 20 is shown immediately below the o-ring shoulder concentric with and immediately adjacent to the top portion of the narrower diameter of the cylindrical insert conduit 13.

FIG. 2 details the relative positions of the unitary discharge nozzle 10 and the base member 22. The cylindrical insert cylinder 13 is seen mated to the tubular sleeve conduit 21 forming a continuous outlet for the dispensing of fluid. The nozzle head 11 is seen resting atop of the base member 22 and tubular sleeve conduit 21. The two locking arms 15 are shown in their locked position within the locking arm cavity 23. The locking head shoulder surfaces 17 are pictured in apposition to locking shoulder catch surfaces 24. Anti-tamper key channels 25 are seen as projections into the base member 22.

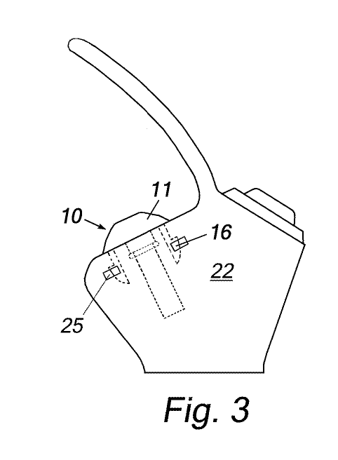

FIG. 3 demonstrates a more encompassing view of the preferred embodiment detailing a side elevation with the base member 22 in the form of a bubbler head for a water fountain. The anti-tamper key channels 25 are seen on end with a partial view of the locking heads 16 in view deep within the base member. The mound formed by the nozzle head 11 is seen to be opposed to the surface of the base member 22. A projection of the portion of the unitary discharge nozzle 10 which lies within the base member 22 is seen as a dashed outline.

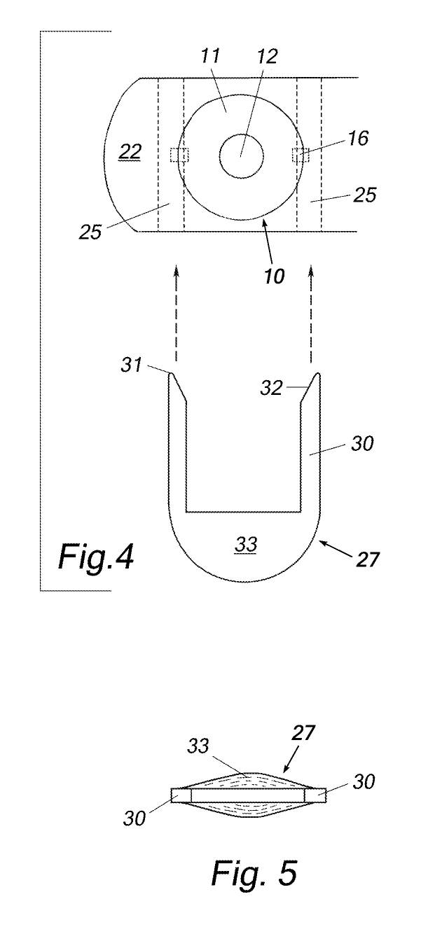

FIG. 4 demonstrates the discharge nozzle 10 from the top and the relative positions of the nozzle head 11, the nozzle head opening 12, the locking heads 16, and the anti-tamper key channels 25 in the base member 22. The orientation of an anti-tamper key 27 and its key prongs 30 with rapport to the anti-tamper key channels 25 necessary for unlocking the discharge nozzle 10 from the base member 22 is demonstrated. The anti-tamper key 27 is seen from the top showing the u-shaped arrangement of the key prongs 30 and a key grip 33. The key prongs 30 extend perpendicularly outward from the key grip 33. The key prongs 30 are parallel to each other and narrow at the slanted key prong ends 32 shown. The slanted key prong ends 32 end in key prong tips 31.

FIG. 5 is a front elevation of the anti-tamper key 27 wherein the key prongs 30 are seen on end and the key grip 33 is seen to have substantial thickness to enhance grasping.

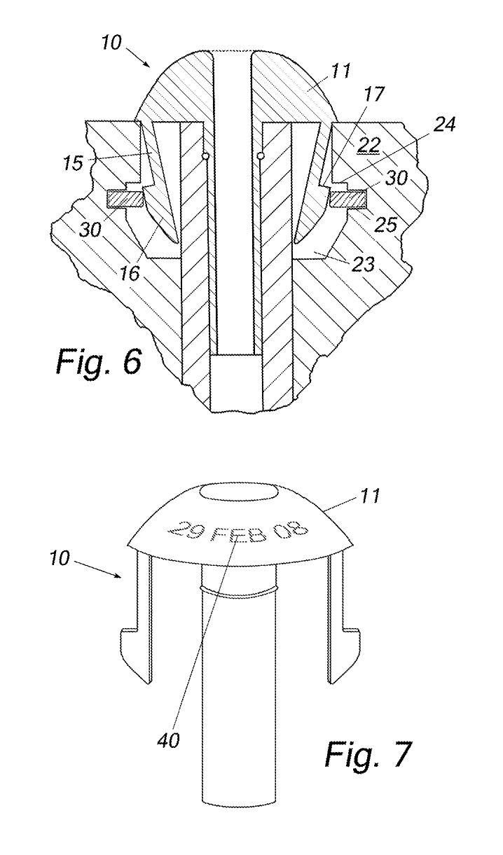

FIG. 6 details the relative positions of the unitary discharge nozzle 10 and the base member 22 as in FIG. 2 but with the key prong tips 30 inserted fully in the anti-tamper key channels 25. The locking arms 15 are seen to be displaced inwardly within the locking arm cavities 23 by pressure of the key prong tips 30 against the locking heads 16. The locking head shoulder surfaces 17 are shown forced clear of the locking shoulder catch surfaces 24.

FIG. 7 shows the discharge nozzle 10 bearing an identifier in the form of a date stamp 40 on the nozzle head 11.

Operation—FIGS. 1, 2, 3, 4, 5, 6, and 7

After a given amount of time the discharge nozzle 10 seated as shown in FIGS. 1 and 3 may not be sanitary. To remove the contaminants and biofilm that may have formed the discharge nozzle 10 can easily be removed from its position in the base member 22 and be quickly exchanged with a new, clean discharge nozzle by use of a key 27. The user can insert the key prongs 30 into the anti-tamper key openings 25 by grasping the key grip and simply pushing the key into the base member 22 as shown in FIG. 4. This action will result in the inward deflection of the locking heads 16 as shown in FIG. 6. The locking head shoulder surfaces 17 will then be clear of the locking shoulder catch surfaces 24 and the user will then be able to freely dislodge the discharge nozzle 10 from the base member 22 by pulling the nozzle head 11 away from the base member 22. A new discharge nozzle 10 can then be inserted into the base member 22 by inserting the insert cylinder 13 into the tubular sleeve conduit 21 and aligning the flexible locking arms 15 with the locking arm cavities 23. The locking noses 18 will then be seated in the opening of the locking arm cavities 23. Downwards pressure will then force the locking heads 16 inwards until the locking head shoulder surfaces 17 snap into the locking shoulder catch surfaces 24. At this point the 0 ring 20 will have been forced into a secure position in the tubular sleeve conduit 21 to provide a water-tight seal. The user will know when to replace the discharge nozzle 10 when prompted by an identifier such as a date stamp 40 plainly visible on the nozzle head 11. Replacing the discharge nozzle 10 may also be prompted by another form of identifier distinguishing one nozzle from another such as a color code within the discharge nozzle 10 to be coordinated by a color coded calendar. An example of this would be to have January of a given year be color coded as blue and white and the corresponding discharge nozzle be made of blue and white material. If then, February of the same year were color coded green, then the corresponding discharge nozzle would be green. Said calendar displayed on a sticker affixed to the fluid dispensing system would then make those wishing to use it aware of whether the nozzle had been changed recently. Identifiers are not limited to the two aforementioned methods.

### ALTERNATIVE EMBODIMENTS

Alternatively the nozzle head can have a variety of notches or flanges to make removal easier. Small openings in the nozzle head could allow use of another tool to insert into these openings and make removal more specific to those with a specially designed tool. The locking arms could be oriented in differing manners for easier manufacture.

1. A fluid dispensing assembly comprising:
a. a removable nozzle means with locking surfaces that locks into a base member
b. a base member with locking surfaces allowing said nozzle means to remain locked to said base member and also allowing access to a locking mechanism by a specific key means to unlock said nozzle means
c. a key means which displaces said locking surfaces to allow unlocking of said nozzle means from said base member.

2. The fluid dispensing assembly of claim 1 wherein said removable nozzle means bears an identifier means to distinguish it from other nozzle means.
